(19) United States
(12) Patent Application Publication
(10) Pub. No.: US 2011/0142017 A1
(43) Pub. Date: Jun. 16, 2011

(54) Differentiated QoS for Wi-Fi clients connected to a cable/DSL network

(75) Inventor: Rex A. Coldren, Phoenix, AZ (US)

(73) Assignee: Alcatel-Lucent USA Inc.

(21) Appl. No.: 12/653,301

(22) Filed: Dec. 11, 2009

(51) Int. Cl. H04W 8/00

(52) U.S. Cl. 370/338

(57) ABSTRACT

The preferred method involves segmenting the routable IP address space of a Cable Modem Termination System (CMTS) to identify clients requiring differentiated QoS by assigning IP addresses from reserved ranges. The IP addresses are assigned to home clients/the Wi-Fi AP and roaming users based on special DHCP options inserted by the Wi-Fi AP DHCP Proxy software on behalf the Wi-Fi AP and home client devices and roaming devices using the Wi-Fi AP. This creates potentially multiple service classes whereby IP addresses from the reserved ranges are included in traffic classifiers that cause packets to map to service flows which provide for differentiated QoS to the Wi-Fi AP owner, home clients and roaming users on the cable access network.

### CROSS REFERENCE TO RELATED APPLICATIONS

This United States non-provisional patent application does not claim priority to any United States provisional patent application or any foreign patent application.

### FIELD OF THE DISCLOSURE

The disclosures made herein relate generally to the telecommunications industry. The invention discussed herein is in the general classification of a method and system for providing differentiated Quality of Service (QoS) for devices sharing a Wi-Fi access point (AP) attached to a network.

### BACKGROUND

This section introduces aspects that may be helpful in facilitating a better understanding of the invention. Accordingly, the statements of this section are to be read in this light and are not to be understood as admissions about what is in the prior art or what is not in the prior art.

Wi-Fi APs may have multiple sub-systems referred to as Service Set Identifiers (SSIDs) with one for the owner of the Wi-Fi AP and his/her home clients and potentially several others for cable operators. The cable operator SSIDs provide roaming service for other cable subscribers using the cable subscribers' residential and small enterprise Wi-Fi APs. The Wi-Fi AP owner's service level agreement (SLA) must be met even in the presence of roaming traffic from other cable subscribers on the Wi-Fi AP. This requires differentiated Quality of Service (QoS) on the Data Over Cable Service Interface Specification (DOCSIS) access network.

Currently, there is no acceptable, existing software solution for providing differentiated QoS on the DOCSIS cable access network for devices sharing a Wi-Fi AP attached to such a network.

Several technical terms will be used throughout this application and merit a brief explanation.

Quality of Service (QoS) refers to a mechanism to control resources in a packet-switched telecommunications network and not to the achieved service quality. Quality of Service allows different priority to be given to different data flows from different users to guarantee a certain level of performance to a data flow from a given user.

A Service Level Agreement (SLA) is a portion of a service contract in which the level of service is formally defined between a customer and a service provider.

Wi-Fi enabled devices can be connected to the Internet when within range of a wireless network connected to the Internet. One or more access points can provide Internet access in private homes and offices or public settings.

A wireless access point or access point (WAP or AP) is a device that permits a wireless communication device to connect to a wireless network using Wi-Fi or other standards. The WAP usually connects to a wired network and allows data packets to be transmitted between wireless devices connected to the WAP and wired devices on the network.

Data Over Cable Service Interface Specification (DOCSIS) is an international standard and defines the communications and operation support interface requirements for a data over cable system.

Service Set Identifier (SSID) is a name that identifies a specific 802.11 wireless Local Area Network (LAN). A client device receives broadcast messages from all APs within range advertising their SSIDs, allowing the device to automatically or manually connect to one of these networks.

A Basic Service Set (BSS) is the building block of an IEEE 802.11 wireless LAN. The AP and the associated stations are called a BSS.

An Internet Protocol (IP) address is a number assigned to devices on a computer network utilizing the Internet Protocol for communication between nodes. IP addresses specify the locations of the source and destination nodes for packets sent on a network.

Dynamic Host Configuration Protocol (DHCP) is a computer networking protocol that allows distribution of IP addresses to a destination host. DHCP allows for a client (computer or other network aware device) to connect to the network, send a DHCP query requesting an IP address from a DHCP server and receive an IP address from the DHCP server.

A Cable Modem Termination System (CMTS) provides high speed data services (e.g. cable Internet) to cable subscribers. A CMTS provides many of the same functions provided by the Digital Subscriber Line Access Multiplexer (DSLAM) in a Digital Subscriber Line (DSL) system.

A Digital Subscriber Line (DSL) provides digital data transmission over wires of a local telephone network. DSL separates the frequencies used in a telephone line into a high-frequency band for Internet service provider data and a low frequency band for voice.

A Digital Subscriber Line Access Multiplexer (DSLAM) permits quicker connections to the Internet for telephone lines. A DSLAM is a device used to connect multiple customer DSLs to a high speed Internet.

A Multiple System Operator (MSO) is an operator of multiple cable television systems.

A Local Area Network (LAN) is a computer network in a small geographical region such as a home or office.

A Virtual Local Area Network (VLAN) is a group of clients that communicate as if they were connected irrespective of their actual geographical location. VLANs are like LANs but do not require VLAN members to be located on the same network switch.

Multiprotocol Label Switching (MPLS) carries traffic from one network node to another network node. In a MPLS network, each data packet has a label that dictates data packet forwarding decisions without the need to examine the data packet.

Network Address Translation (NAT) allows for changing network address information in a data packet header while it is traveling across a routing device.

### SUMMARY OF THE DISCLOSURE

The preferred method involves segmenting the routable IP address space of a Cable Modem Termination System (CMTS) to identify clients requiring differentiated QoS by assigning IP addresses from reserved ranges. The IP addresses are assigned to home clients (also referred to as home client devices)/the Wi-Fi AP (home users) and roaming users based on special DHCP options inserted by the Wi-Fi AP DHCP Proxy software on behalf of the Wi-Fi home clients, the Wi-Fi AP and the roaming users. This creates potentially multiple service classes whereby IP addresses from the reserved ranges are included in traffic classifiers that cause packets to map to service flows which provide for differentiated QoS to the Wi-Fi AP owner and home clients as well as roaming users on the cable access network.

The preferred method can be applied to Wi-Fi APs on cable or Digital Subscriber Line (DSL) networks when the DSL access network deploys IP-based Digital Subscriber Line Access Muliplexers (DSLAMs).

The preferred method removes the need for a special network access gateway which terminates secured tunnels to and from the Wi-Fi APs.

The preferred method for acquiring a reserved (specialized) IP address to provide differentiated QoS to the home client devices and roaming devices connected to a Wi-Fi access point involves receiving DHCP signaling from a home client device or a roaming device at a Wi-Fi access point; inserting a special option into the DHCP signaling at the Wi-Fi access point to request an IP address from a reserved range of IP addresses from a DHCP server; transmitting the DHCP signaling with the special option from the Wi-Fi access point to the DHCP server; receiving an IP address from the reserved range for the home client device or the roaming device at the Wi-Fi access point; and sending the IP address from the Wi-Fi access point to the home client device or the roaming device.

The preferred method for providing differentiated Quality of Service (QoS) for clients sharing a Wi-Fi access point (AP) attached to a Data Over Cable Service Interface. Specification (DOCSIS) cable access network involves mapping upstream traffic coming from a home client device and roaming device with source IP addresses from reserved ranges of IP addresses to uniquely provisioned DOCSIS service flows at a cable modem; forwarding downstream traffic coming from a CMTS from the uniquely provisioned DOCSIS service flows onto a cable modem/Wi-Fi access point Ethernet link according to service flow priority at the cable modem; forwarding upstream traffic coming from the cable modem from the uniquely provisioned DOCSIS service flows to a physical output port according to service flow priority at the CMTS; and mapping downstream traffic at the CMTS to the uniquely provisioned DOCSIS service flows based on destination IP addresses being in the reserved ranges of IP addresses.

Under some applications, embodiments may provide a method that is relatively inexpensive to implement that provides differentiated Quality of Service (QoS) for clients sharing a Wi-Fi access point (AP) attached to a network.

Under some applications, embodiments may provide a method that is not operationally complex that provides differentiated Quality of Service (QoS) for clients sharing a Wi-Fi access point (AP) attached to a network.

Under some applications, embodiments may provide a method that can scale to residential Wi-Fi AP numbers to provide differentiated Quality of Service (QoS) for clients sharing a Wi-Fi access point (AP) attached to a network.

Under some applications, embodiments may provide a method that efficiently provides differentiated Quality of Service (QoS) for clients sharing a Wi-Fi access point (AP) attached to a network.

Under some applications, embodiments may provide a reliable method to provide differentiated Quality of Service (QoS) for clients sharing a Wi-Fi access point (AP) attached to a network.

Under some applications, embodiments may provide a system that is relatively inexpensive to manufacture and deploy for providing differentiated Quality of Service (QoS) for clients sharing a Wi-Fi access point (AP) attached to a network.

### BRIEF DESCRIPTION OF THE DRAWINGS

Some embodiments of apparatus and/or methods of the present invention are now described, by way of example only, and with reference to the accompanying drawings, in which:

FIG. 1 schematically illustrates a system for a Wi-Fi access point acquiring a reserved (specialized) IP address from a reserved range of IP addresses to provide differentiated QoS to the Wi-Fi access point, home client devices and roaming devices connected to the Wi-Fi access point.

FIG. 2 schematically illustrates a system showing user data plane traffic flows that provide differentiated QoS to a Wi-Fi access point, home clients and roaming devices connected to the Wi-Fi access point.

FIG. 3 depicts the method of the preferred embodiment for acquiring a reserved (specialized) IP address to provide differentiated QoS to devices connected to the Wi-Fi access point.

FIG. 4 depicts the method of the preferred embodiment for providing differentiated Quality of Service (QoS) for clients sharing a Wi-Fi access point (AP) attached to a Data Over Cable Service Interface Specification (DOCSIS) cable access network.

### DETAILED DESCRIPTION OF THE DRAWINGS

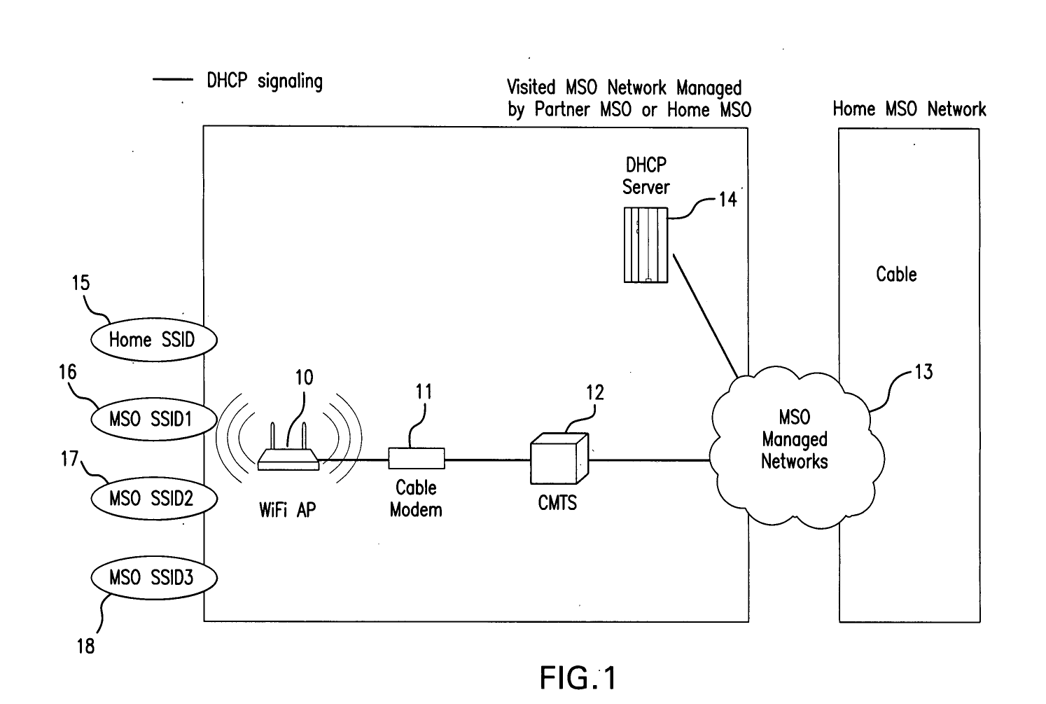

FIG. 1 schematically illustrates a system for a Wi-Fi access point acquiring a reserved (specialized) IP address from a reserved range of IP addresses to provide differentiated QoS to the Wi-Fi access point, home client devices and roaming devices connected to the Wi-Fi access point.

A Wi-Fi AP 10 has an Ethernet connection to a cable modem 11. The cable modem 11 connects to a Cable Modem Termination System (CMTS) 12. The CMTS 12 connects to Multiple System Operator (MSO) Managed Networks 13. The MSO Managed Networks 13 connect to a DHCP Server 14 that assigns IP addresses to the home client devices and roaming devices attached to the Wi-Fi AP 10 and the Wi-Fi AP 10.

The Wi-Fi AP 10 implements a DHCP proxy that inserts special options into DHCP signaling received from home and roaming user client devices on the Wi-Fi access interface. The home SSID may use network address translation (NAT), in which case traffic to and from home client devices makes use of the Wi-Fi AP IP address rather than the home client device IP address, which would come from a private address space used by the Wi-Fi AP 10.

A special code or option is inserted into the DHCP proxy at the Wi-Fi AP 10, resulting in the DHCP server 14 segmenting the routable IP address space of the CMTS 12 when it receives the DHCP proxy to create IP address ranges. The CMTS 12 and cable modem 11 map IP address ranges to DOCSIS service flows for downstream and upstream traffic, respectively.

The Wi-Fi AP 10 of this preferred embodiment contains a memory for storing instructions and a processor for processing those instructions. The instructions being processed include instructions for receiving DHCP signaling from a device at a Wi-Fi access point; inserting a special option into the DHCP signaling at the Wi-Fi access point to request an IP address from a reserved range of IP addresses from a DHCP server; transmitting the DHCP signaling with the special option from the Wi-Fi access point to the DHCP server; receiving an IP address from the reserved range for the device at the Wi-Fi access point; and sending the IP address from the Wi-Fi access point to the device.

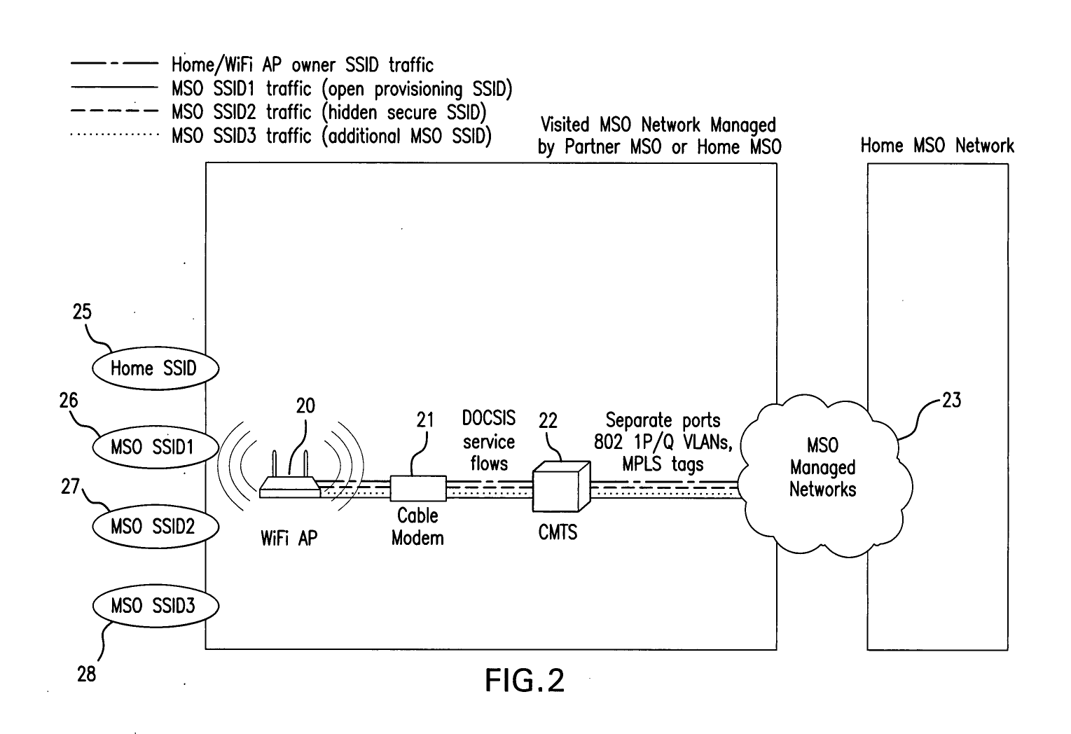

FIG. 2 schematically illustrates a system showing user data plane traffic flows that provide differentiated QoS to a Wi-Fi access point, home clients and roaming devices connected to the Wi-Fi access point.

A Wi-Fi AP 20 has an Ethernet connection to connect to a cable modem 21. The cable modem 21 connects to CMTS 22 and permits DOCSIS service flows to support differentiated service classes. The CMTS 22 connects to the MSO managed networks 23 and communicates through separate ports based on 802.1P/Q VLANs and MPLS tags.

The Wi-Fi AP 20 provides separate virtual wireless LANs (multiple basic service sets (BSSs) with different SSIDs) for home and roaming users. The Wi-Fi AP 20 provides priority treatment for home SSID traffic and the ability to provide differentiated services to different classes of roaming users connected via the multiple MSO SSIDs.

The cable modem 21 maps upstream traffic from source IP address reserved ranges to uniquely provisioned DOCSIS service flows and forwards downstream traffic from service flows onto the cable modem/Wi-Fi AP Ethernet link according to service flow priority.

The CMTS 22 maps upstream service flows to physical output port, 802.1 P/Q VLAN or MPLS tunnel as configured. The CMTS 22 maps downstream traffic to appropriate DOCSIS service flows based on destination IP address ranges.

In the preferred embodiment depicted in FIG. 2, four separate DOCSIS service flows are shown. A higher priority is assigned to the Home/Wi-Fi AP owner SSID traffic while lower priorities are assigned to MSO SSID1 traffic, MSO SSID2 traffic and MSO SSID3 traffic. Traffic that includes a source IP address from the reserved ranges of IP addresses is mapped by the cable modem 21 to DOCSIS service flows with priority over other service flows, based upon configuration of DOCSIS traffic classifiers that map to the respective service flows. Downstream traffic that includes a destination IP address from the reserved ranges of IP addresses is accordingly mapped by the CMTS 22 to DOCSIS service flows with priority over other service flows based on the configuration of DOCSIS traffic classifiers that map to the respective service flows.

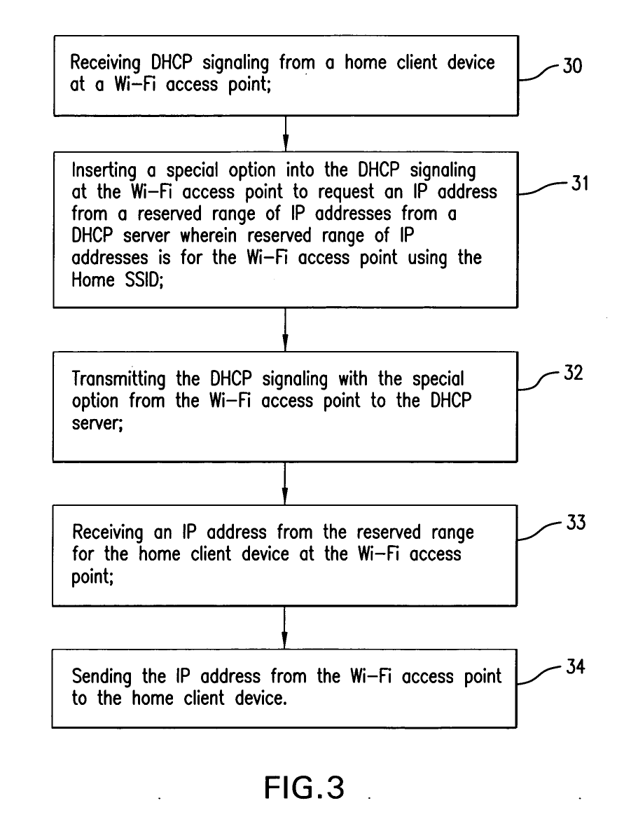

FIG. 3 depicts the method of the preferred embodiment for acquiring a reserved (specialized) IP address to provide differentiated QoS to the devices connected to the Wi-Fi access point.

An operation for receiving DHCP signaling from a home client device at a Wi-Fi access point 30 is performed. An operation for inserting a special option into the DHCP signaling at the Wi-Fi access point to request an IP address from a reserved range of IP addresses from a DHCP server wherein the reserved range of IP addresses is for the Wi-Fi access point and all home client devices connected to the Wi-Fi access point using the Home SSID 31 is performed. An operation for transmitting the DHCP signaling with the special option from the Wi-Fi access point to the DHCP server 32 is performed. An operation for receiving an IP address from the reserved range for the home client device at the Wi-Fi access point 33 is performed. An operation for sending the IP address from the Wi-Fi access point to the home client device 34 is then performed.

Alternatively, if the IP address is being acquired for the Wi-Fi access point itself, an operation for inserting a special option into the DHCP signaling at the Wi-Fi access point to request an IP address from a reserved range of IP addresses from a DHCP server is performed. Then, an operation for transmitting the DHCP signaling with the special option from the Wi-Fi access point to the DHCP server is performed. Then an operation for receiving an IP address from the reserved range for the Wi-Fi access point is performed.

Alternatively, if the IP address is being acquired for a roaming device, an operation for receiving DHCP signaling from the roaming device at a Wi-Fi access point is performed. An operation for inserting a special option into the DHCP signaling at the Wi-Fi access point to request an IP address from a reserved range of IP addresses from a DHCP server wherein the reserved range of IP addresses is for all roaming devices connected to the Wi-Fi access point using a MSO SSID is performed. An operation for transmitting the DHCP signaling with the special option from the Wi-Fi access point to the DHCP server is performed. An operation for receiving an IP address from the reserved range for the roaming device at the Wi-Fi access point is performed. An operation for sending the IP address from the Wi-Fi access point to the roaming device is then performed.

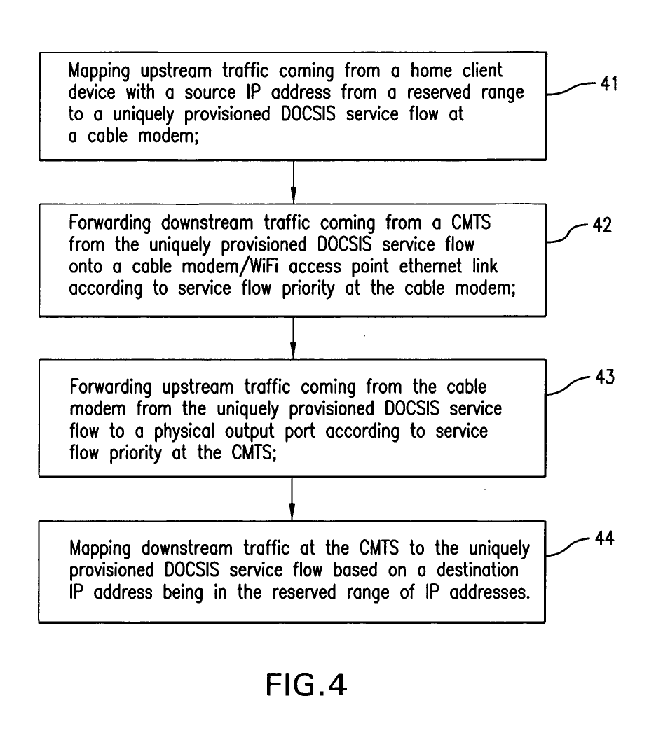

FIG. 4 depicts the method of the preferred embodiment for providing differentiated Quality of Service (QoS) for clients sharing a Wi-Fi access point (AP) attached to a Data Over Cable Service Interface Specification (DOCSIS) cable access network.

An operation for mapping upstream traffic coming from a home client device with a source IP address from a reserved range of IP addresses to a uniquely provisioned DOCSIS service flow at a cable modem 41 is performed. An operation for forwarding downstream traffic coming from a CMTS from the uniquely provisioned DOCSIS service flow onto a cable modem/Wi-Fi access point Ethernet link according to service flow priority at the cable modem 42 is performed. A forwarding upstream traffic coming from the cable modem from the uniquely provisioned DOCSIS service flow to a physical output port according to service flow priority at the CMTS 43 operation is performed. A mapping downstream traffic at the CMTS to the uniquely provisioned DOCSIS service flow based on a destination IP address being in the reserved range of IP addresses 44 is performed.

In the case of at least three roaming devices using three separate MSO SSIDs on the Wi-Fi AP along with the home client devices using the Home SSID on the Wi-Fi AP, there can be further operations for mapping upstream traffic coming from a roaming device with a source IP address from a second reserved range of IP addresses to a second uniquely provisioned DOCSIS service flow at a cable modem; for forwarding downstream traffic coming from a CMTS from the second uniquely provisioned DOCSIS service flow onto a cable modem/Wi-Fi access point Ethernet link according to service flow priority at the cable modem; for forwarding upstream traffic coming from the cable modem from the second uniquely provisioned DOCSIS service flow to a physical output port according to service flow priority at the CMTS; for mapping downstream traffic at the CMTS to the second uniquely provisioned DOCSIS service flow based on a destination IP address being in the second reserved range of IP addresses; for mapping upstream traffic coming from a second roaming device with a source IP address from a third reserved range of IP addresses to a third uniquely provisioned DOCSIS service flow at a cable modem; for forwarding downstream traffic coming from a CMTS from the third uniquely provisioned DOCSIS service flow onto a cable modem/Wi-Fi access point Ethernet link according to service flow priority at the cable modem; for forwarding upstream traffic coming from the cable modem from the third uniquely provisioned DOCSIS service flow to a physical output port according to service flow priority at the CMTS; for mapping downstream traffic at the CMTS to the third uniquely provisioned DOCSIS service flow based on a destination IP address being in the third reserved range of IP addresses; for mapping upstream traffic coming from a third roaming device with a source IP address from a fourth reserved range of IP addresses to a fourth uniquely provisioned DOCSIS service flow at a cable modem; for forwarding downstream traffic coming from a CMTS from the fourth uniquely provisioned DOCSIS service flow onto a cable modem/Wi-Fi access point Ethernet link according to service flow priority at the cable modem; for forwarding upstream traffic coming from the cable modem from the fourth uniquely provisioned DOCSIS service flow to a physical output port according to service flow priority at the CMTS; and for mapping downstream traffic at the CMTS to the fourth uniquely provisioned DOCSIS service flow based on a destination IP address being in the fourth reserved range of IP addresses.

Although four SSIDs (3 MSO SSIDs and 1 Home SSID) are used and described in the figures, it should be apparent to one skilled in the art that more or fewer SSIDs may also be used without departing from the spirit of the invention. Devices connected to the AP via any given SSID could be assigned an IP address from a range of IP addresses and packets going to or coming from these devices could be mapped to service flows in which certain service flows could be given priority over other service flows.

It is contemplated that the method described herein can be implemented as software, including a computer-readable medium having program instructions executing on a computer, hardware, firmware, or a combination thereof. The method described herein also may be implemented in various combinations on hardware and/or software.

A person of skill in the art would readily recognize that steps of the various above-described methods can be performed by programmed computers and the order of the steps is not necessarily critical. Herein, some embodiments are intended to cover program storage devices, e.g., digital data storage media, which are machine or computer readable and encode machine-executable or computer executable programs of instructions where said instructions perform some or all of the steps of methods described herein. The program storage devices may be, e.g., digital memories, magnetic storage media such as magnetic disks or taps, hard drives, or optically readable digital data storage media. The embodiments are also intended to cover computers programmed to perform said steps of methods described herein.

It will be recognized by those skilled in the art that changes or modifications may be made to the above-described embodiments without departing from the broad inventive concepts of the invention. It should therefore be understood that this invention is not limited to the particular embodiments described herein, but is of the invention as set forth in the claims.

What is claimed is:

1. A method for acquiring a reserved Internet Protocol (IP) address to provide differentiated Quality of Service (QoS) to a Wi-Fi access point and devices connected to the Wi-Fi access point comprising the step of:
inserting a special option into a Dynamic Host Configuration Protocol (DHCP) signaling at the Wi-Fi access point to request an IP address from a reserved range of IP addresses from a DHCP server.

2. The method of claim 1 further comprising the step of:
transmitting the DHCP signaling with the special option from the Wi-Fi access point to the DHCP server.

3. The method of claim 2 further comprising the step of:
receiving an IP address from the reserved range of IP addresses at the Wi-Fi access point.

4. The method of claim 1 further comprising the step of:
receiving the DHCP signaling from a home client device at the Wi-Fi access point wherein the reserved range of IP addresses is for the Wi-Fi access point and all home client devices connected to the Wi-Fi access point using a Home SSID.

5. The method of claim 4 further comprising the step of:
sending the IP address from the reserved range of IP addresses from the Wi-Fi access point to the home client device.

6. The method of claim 1 further comprising the step of:
receiving the DHCP signaling from a roaming device at the Wi-Fi access point wherein the reserved range of IP addresses is for all roaming devices connected to the Wi-Fi access point using a MSO SSID.

7. The method of claim 6 further comprising the step of:
sending the IP address from the reserved range of IP addresses from the Wi-Fi access point to the roaming device.

8. A method for providing differentiated Quality of Service (QoS) for devices sharing a Wi-Fi access point (AP) attached to a network comprising the step of:
mapping upstream traffic coming from a home client device with a source IP address from a reserved range of IP addresses to a uniquely provisioned service flow at a cable modem.

9. The method of claim 8 further comprising the step of:
forwarding upstream traffic coming from the cable modem from the uniquely provisioned service flow to a physical output port according to service flow priority at a Cable Modem Termination System (CMTS).

10. The method of claim 9 further comprising the step of:
forwarding downstream traffic coming from the CMTS from the uniquely provisioned service flow onto a cable modem/Wi-Fi access point link according to service flow priority at the cable modem.

11. The method of claim 10 further comprising the step of:
mapping downstream traffic at the CMTS to the uniquely provisioned service flow based on a destination IP address being in the reserved range of IP addresses.

12. The method of claim 11 further comprising the steps of:
mapping upstream traffic coming from a roaming device with a source IP address from a second reserved range of IP addresses to a second uniquely provisioned service flow at the cable modem; forwarding downstream traffic coming from the CMTS from the second uniquely provisioned service flow onto the cable modem/Wi-Fi access point link according to service flow priority at the cable modem; forwarding upstream traffic coming from the cable modem from the second uniquely provisioned service flow to a physical output port according to service flow priority at the CMTS; and mapping downstream traffic at the CMTS to the second uniquely provisioned service flow based on a destination IP address being in the second reserved range of IP addresses.

13. The method of claim 12 further comprising the steps of:
mapping upstream traffic coming from a second roaming device with a source IP address from a third reserved range of IP addresses to a third uniquely provisioned service flow at the cable modem; forwarding downstream traffic coming from the CMTS from the third uniquely provisioned service flow onto the cable modem/Wi-Fi access point link according to service flow priority at the cable modem; forwarding upstream traffic coming from the cable modem from the third uniquely provisioned service flow to a physical output port according to service flow priority at the CMTS; and mapping downstream traffic at the CMTS to the third uniquely provisioned service flow based on a destination IP address being in the third reserved range of IP addresses.

14. The method of claim 13 further comprising the steps of:
mapping upstream traffic coming from a third roaming device with a source IP address from a fourth reserved range of IP addresses to a fourth uniquely provisioned service flow at the cable modem; forwarding downstream traffic coming from the CMTS from the fourth uniquely provisioned service flow onto the cable modem/Wi-Fi access point link according to service flow priority at the cable modem; forwarding upstream traffic coming from the cable modem from the fourth uniquely provisioned service flow to a physical output port according to service flow priority at the CMTS; and mapping downstream traffic at the CMTS to the fourth uniquely provisioned service flow based on a destination IP address being in the fourth reserved range of IP addresses.

15. A system for acquiring reserved IP addresses to provide differentiated Quality of Service (QoS) to a Wi-Fi access point and devices connected to the Wi-Fi access point comprising:
(a) a cable modem connected to a Cable Modem Termination System (CMTS) which is connected to at least one MSO managed network; and
(b) a Wi-Fi access point connected to the cable modem and having a memory containing instructions processed by a processor for inserting a special option into a DHCP signaling at the Wi-Fi access point to request an IP address from a reserved range of IP addresses from a DHCP server.

16. The system of claim 15 wherein the memory further includes instructions for receiving the DHCP signaling from a device at the Wi-Fi access point, transmitting the DHCP signaling with the special option from the Wi-Fi access point to the DHCP server; receiving an IP address from the reserved range of IP addresses for the device at the Wi-Fi access point; and sending the IP address from the Wi-Fi access point to the device.

17. The system of claim 16 wherein the device is a home client device connected to the Wi-Fi access point via a Home SSID.

18. The system of claim 16 wherein the device is a roaming device connected to the Wi-Fi access point via a MSO SSID.
